(19) United States
(12) Patent Application Publication
(10) Pub. No.: US 2004/0093262 A1
(43) Pub. Date: May 13, 2004

(54) Method and apparatus for collecting and analyzing the sale and use of pre-recorded entertainment products

(76) Inventors: John Weston, Douglaston, NY (US); Timothy J. Davis, Marstons Mills, MA (US); Christopher Berlandier, San Clemente, CA (US)

Correspondence Address: CONNOLLY BOVE LODGE & HUTZ LLP, SUITE 800, 1990 M STREET NW, WASHINGTON, DC, 20036-3425, US

(21) Appl. No.: 10/349,037

(22) Filed: Jan. 23, 2003

Related U.S. Application Data
(60) Provisional application No. 60/424,702, filed on Nov. 8, 2002.

(51) Int. Cl. G06F 17/60

(52) U.S. Cl. 705/10

(57) ABSTRACT

A method and apparatus are described for collecting and analyzing information relating to the sale of pre-recorded entertainment products. The point-of-sale information is collected to identify the purchase of pre-recorded product from traditional retail outlets as well as from on-line facilities where such products are sold. The information is collected at a common collection agent, and the information is parsed into various fields and expanded to include data relating to each pre-recorded product identified from the point-of-sale and on-line information. The expanded point-of-sale information is stored in a data repository where clients and affiliates can access the data using various filtering criteria. Real-time sales and marketing information becomes available on a demand basis for the clients and affiliates.

### CROSS-REFERENCE TO RELATED APPLICATIONS

This is a non-provisional Patent Application and claims the benefit of U.S. Provisional Application No. 60/424,702, filed Nov. 8, 2002.

### BACKGROUND OF THE INVENTION

The present invention is directed to a system which provides essentially real time analysis of consumer purchasing preferences of entertainment products such as pre-recorded audio and video products. Specifically, a method and system is disclosed for collecting point-of-sale or use information from various locations to provide a searchable database which identifies purchasing habits of consumers.

The effective marketing of such products requires a constant analysis of consumer purchasing trends in order to determine the demand for pre-recorded audio and video products. In the music industry in particular, the average life span of a new product release, with respect to promoting and marketing is 8-12 weeks. The music industry may produce 38,000 pre-recorded audio products, with the expectation that less than 0.5% of these recorded products will be successful, and it is necessary to identify the more successful pre-recorded products in the relatively short life span available for promoting a new release. Marketing decisions based on previous trends are inherently unreliable given the historically short shelf life of a pre-recorded product. As little as one week of misdirected sales and promotion resources can cost a label up to a $40,000 per release.

Further complicating the ability to quickly identify consumer demand for a pre-recorded product release is the existence of regional and local markets for such products. Accordingly, it is necessary to know not only national trends and demand for pre-recorded audio and video products, but to recognize a regional and local demand to maximize sales for such products.

The traditional source of information for measuring consumer demand has been the retailer of pre-recorded audio and video products. These traditional outlets have now been supplemented by Internet transactions that permit users to either purchase pre-recorded audio and video products, or in some cases, sample the products prior to a purchase by listening or viewing the product on a streaming basis. Internet websites permit consumers to shop and browse among pre-recorded audio and video products that were formerly only available in traditional retail outlets. Currently there is no research tool to analyze pre-recorded audio and video products sold over the Internet. A complete assessment of customer preferences now requires information regarding the sale and use of pre-recorded audio and video products from traditional retail outlets as well as from Internet websites.

### SUMMARY OF THE INVENTION

In accordance with the invention, a method and apparatus are provided for collecting and analyzing the use and sale of pre-recorded entertainment products such as audio and video products and other electronic entertainment media. The invention provides for substantially real-time monitoring of sales information collected from retail point-of-sale locations, as well as from Internet websites through which sales of such pre-recorded products take place. The sales information is collected and reported in a file, on either a demand basis or on a periodic basis, to a collection agent over an Internet network connection. The received information is parsed into individual data fields, and expanded to include data relating to each pre-recorded product identified from the collected information and stored in a data base repository. Affiliates are users that contribute their sales information to the collection agent. Clients are users that pay for access to the collection agent. Affiliates and clients with Internet network access can access selected portions of the expanded sales information to assess consumer demand and preferences.

In accordance with one aspect of the invention, the expanded information includes a transactional time stamp as well as geographical information identifying where sales have occurred. Clients and affiliates can remotely access the information based on any criteria through the use of appropriate filters that reside in a graphical user interface (GUI) connected to the database.

The collected information can be sorted and accessed based on various criteria, including (for audio products) by artist, label, genre, performer, studio and region or localities where sales of specific titles are taking place. In this way, the industry may measure and react to consumer demand on a substantially real-time basis to match promotional efforts with consumer preferences on a substantially real time basis.

### BRIEF DESCRIPTION OF THE DRAWINGS

FIG. 1 is a system block diagram of the data collection and reporting system of a preferred embodiment of the invention;

FIG. 2 illustrates the form of a record sent by the point-of-sales location or Internet website to the collection agent;

FIG. 3 illustrates the log file transferred by an on-line website to the collection agent;

FIG. 4 illustrates the collection agent of a preferred embodiment of the invention;

FIG. 5a illustrates data records of point-of-sale and Internet sales records stored in the data repository of the collection agent;

FIG. 5b illustrates data records of downloads occurring over the Internet that have been reported to the collection agent;

FIG. 5c illustrates data records of streaming data;

FIG. 6 is a screen display showing a menu of the major modules and their sub-modules;

FIG. 7 is a screen display showing the Artists & Title screen of the GUI;

FIG. 8 is a screen display showing the User Preferences screen of the GUI;

FIG. 9 is a screen display showing the Report Filter screen for My Artists of the GUI;

FIG. 10 is a screen display showing the artist by label screen of the GUI;

FIG. 11 is a screen display showing the MyArtists screen of the GUI;

FIG. 12 is a screen display showing the Report Filter screen for the Video Sales screen of the GUI;

FIG. 13 is a screen display showing the Video Search screen of the GUI;

FIG. 14 is a screen display showing the Video Sales chart screen of the GUI;

FIG. 15 is a screen display showing the Video Streaming Chart screen of the GUI;

FIG. 16 is a screen display showing a Regional Sales Report screen of the GUI;

FIG. 17 is a screen display showing the National Unsigned/Independent Album Sales Chart screen of the GUI;

FIG. 18 is a screen display showing the Regional Unsigned/Independent Album Sales Chart screen of the GUI;

FIG. 19 is a screen display showing the National Streaming screen of the GUI;

FIG. 20 is a screen display showing the Regional Unsigned/Independent Sales Chart screen of the GUI;

FIG. 21 is a screen display showing the National Album Sales screen of the GUI;

FIG. 22 is a screen display showing the Regional Title Sales Chart screen of the GUI;

FIG. 23 is a screen display showing the Affiliate Streaming screen of the GUI;

FIG. 24 is a screen display showing the National Album Pre-release Chart screen of the GUI;

FIG. 25 is a screen display showing the Regional Album Sales Chart screen of the GUI;

FIG. 26 is a screen display showing the User Administration screen of the GUI;

FIG. 27 is a screen display showing the Music Director screen of the GUI;

FIG. 28 is a screen display showing the Edit Unknown Sales screen of the GUI; and

FIG. 29 is a screen display showing the Unknown Sales Stats screen of the GUI.

### DESCRIPTION OF THE PREFERRED EMBODIMENT

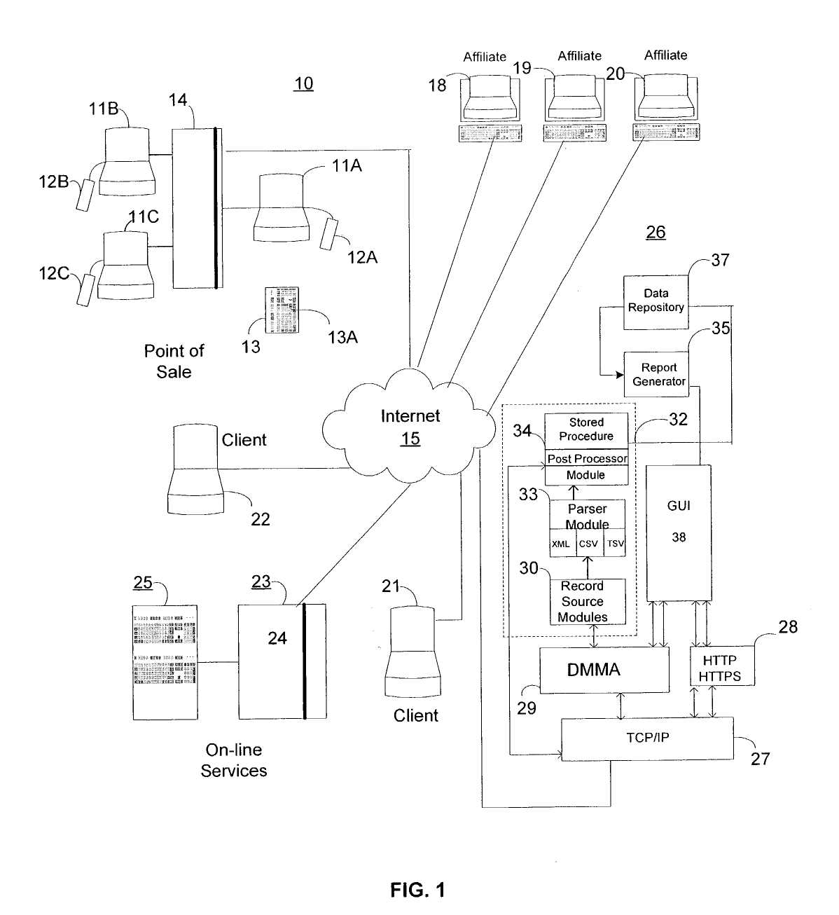

Referring to FIG. 1, a preferred embodiment of a system for collecting and analyzing information concerning the sale and use of pre-recorded products is shown. Such prerecorded products may include audio CDs, DVDs, computer game software as well as digitally recorded books. The preferred embodiment of FIG. 1 collects sales information for pre-recorded products from various traditional point-of-sale locations 10 which retail pre-recorded products 13. These pre-recorded products 13 typically include barcode indicia 13A which can be read by a scanning probe 12A connected to a sales terminal 11A when the sale of the pre-recorded product 13 takes place at the sales terminal 11A. The barcode indicium 13A identifies the pre-recorded product 13 and may include a universal product code (UPC code) which is used by the music/video industry to identify at least one of the following:

1. Artist;

2. Title;

3. Album Name/Track Name;

4. Media format;

5. Label Name;

6. Distributor Name;

7. Street Date;

8. Genre;

9. Performer;

10. Studio Name;

11. Catalog Number;

12. Pre-release;

13. Album/Single (format);

14. Independent;

15. Current Music; and

16. Source SP/SPU.

The point-of-sale locations 10 may include a plurality of sales terminals 11A, 11B, 11C distributed throughout the retail establishment and connected via a local area or wireless network to a computer server 14. The computer server 14 includes a database which collects sales information scanned in through the barcode readers 12A, 12B, 12C as well as other information pertaining to the point-of-sale location.

The barcode number is stored in the database of the computer server 14 as a record which also includes a zip code for the retail establishment, an indication whether or not the item is a new or used pre-recorded product sale, and a time stamp identifying the date and time of the sale. In some point-of-sales locations 10 it may be possible to enter a billing zip code of the customer that is collected with the other data pertaining to the sale.

The distributor data indicates one supplier of a label/item. A catalog number is a number used in conjunction with the label to order specific items. A street date is included identifying when the item is to be released for sale to the general public. A genre represents a specific music or video category (i.e., pop, rock, comedy, drama) known in the industry. The media format extension identifies the specific media by separating CDs from CD singles, cassettes from maxi singles, LPs from 12-inch singles, DVDs from VHS tapes, etc., as follows:

| | |
|---|---|
| 1. | 12-inches vinyl (LP or 12-inches single) |
| 2. | Compact Disk (full length or single 5 or 8) |
| 3. | VHS Video |
| 4. | Cassette (Full length single, maxi single) |
| 5. | SACD (Super Audio Compact Disk) |
| 6. | V Album |
| 7. | DVD/Audio DVD |
| 8. | Mini Disk |
| 9. | Accessories |

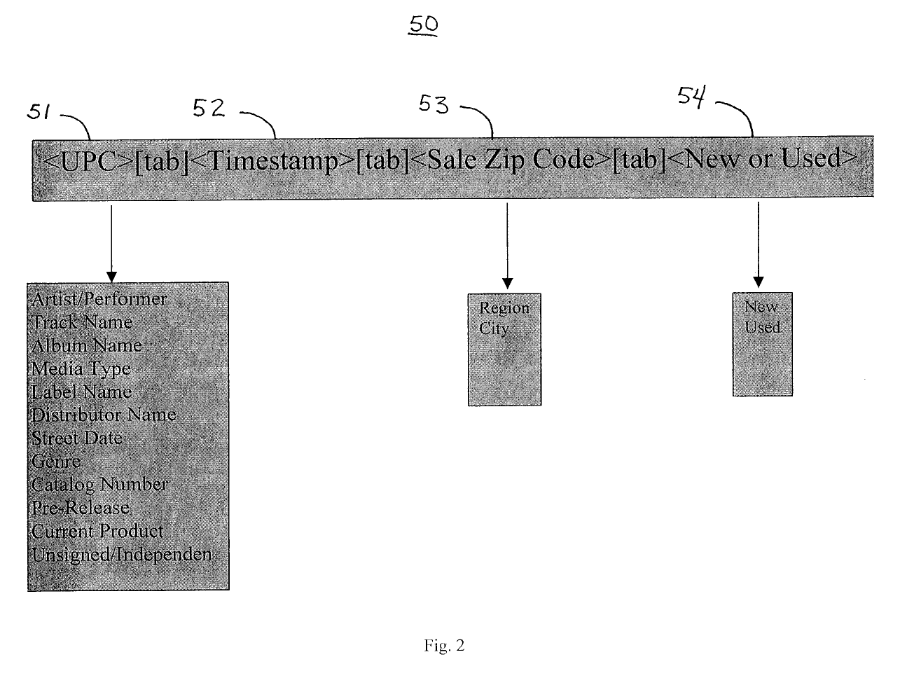

FIG. 2 illustrates a sales record of each sale stored in the collection file accumulated at the point-of-sale computer server 14 database. The collection file 20 consists of at least the UPC number 51 read from the barcode 13A, a transactional time stamp 52 identifying the date and time in which the sale occurred, a sale location zip code 53 is inserted in the record based on the location of the retail outlet or “ship to” zip code, and a new or used product field 54.

The sales records are kept in several formats including flat files, dBase files, relational database structures, etc. on the computer server 14 database where they can be extracted directly or formatted into CSV, TSV, or XML files and then posted on a regular basis to a URL address for the collection agent 26. By posting the information on a regular periodic basis, nearly real time sales information becomes available at the collection agent 26 from numerous retail point-of-sale locations 10 throughout the country. In still other embodiments of the invention, instead of having the computer server 14 database post the data over a secure HTTP (HTTPS) connection using a POST command, the computer server 14 database may permit access by the collection agent 26 utilizing a stored procedure within the computer server 14 database or perform a structured query directly to the data source.

Additional sources of information regarding consumer demand for pre-recorded music or video products may be obtained by collecting information at Internet websites which provide for on-line product distribution. These Internet websites 23, illustrated generally in FIG. 1, permit users to access a library of pre-recorded products 25, and either order them for sale, download, or in some instances permit consumers to listen to portions of the pre-recorded products 25. In the case of sales of pre-recorded products 25 taking place from the Internet website 23, the same sales record information is collected as from the retail point-of-sale locations 10, and stored in a local database. The collected sales record information is posted at periodic intervals, in a CSV, TSV, or XML file for transfer to the collection agent 26.

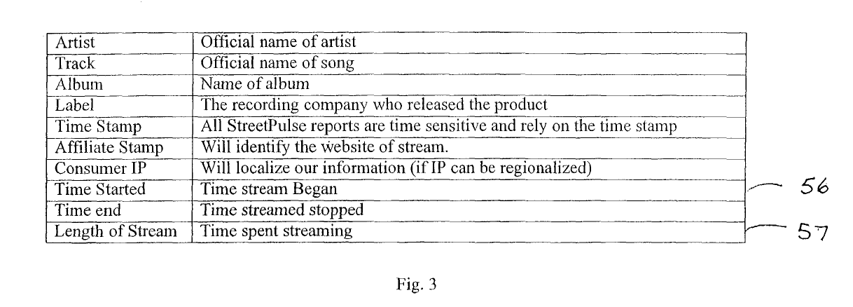

When the Internet website 23 offers streaming services, a log file is created, as shown in FIG. 3, that includes a file identification being streamed, as well as the time of streaming 56 and a duration of streaming 57. This information, pre-recorded product, and any other retail sales data, is sent to the collection agent 26, wherein selections that were requested by the public in a streaming application may be identified from the file identification and the duration of streaming 57, for assessment as to the demand for the particular pre-recorded products.

A collection agent 26 receives the post made by all of the point-of-sale locations 10 computer server 14 databases and the streaming data log files 50c maintained by Internet website 23. The collected data is parsed into individual records, expanded by the collection agent 26 and stored in a data repository 37 for access by various affiliates 18, 19, 20 and clients 21, 22. In accordance with the preferred embodiment, affiliates 18, 19, 20 and clients 21, 22 have different access privileges to the collected information in the data repository 37. Affiliates are users that contribute their sales information to the collection agent. Clients are users that pay for access to the collection agent. Records are posted to the collection agent 26 at least once every 24 hours so that clients 18, 19, 20 and affiliates 21, 22 have essentially real time access to sales and use data representing the demand for individual pre-recorded products.

The collection agent 26 is a computer programmed to include a plurality of software modules 30, 33, and 34, as well as a front-end GUI 38. The collection agent 26 may be a platform which includes a processor for executing software modules 30, 33, and 34, as well as another processor figured as a server and supporting the GUI 38. The processors are linked together over a local area network, such as an Internet based network and functions as a single platform. Communications with the computer implemented collection agent 26 occurs through a TCP/IP interface 27 and DMMA module 29. The modules can be written in standard programming languages such as JAVA, C++ and CFML. Each of the modules communicates with each other via the DMMA interface 29 that provides for encryption and authentication.

The processed data collected from the various point-of-sale locations 10 and Internet websites 23 are processed by the plurality of modules and stored in the data repository 37. The GUI 38 permits access to the data so that reports may be written from a report generator 35 as specified by the clients 21, 22 and affiliates 18, 19, and 20 of the system.

The collection agent 26 is connected to the Internet public network15 through a TCP/IP interface 27. Information received from any of the retail point-of-sale locations 10 or Internet websites 23 can be encrypted using DMMA, a secured communication protocol that operates over TCP/IP. The DMMA secure protocol is described more particularly in U.S. patent application Ser. No. 09/590,822, filed June, 2000, and hereby incorporated by reference. The DMMA secure communications protocol uses 3DES or AES encryption techniques so that the data is secure against unauthorized access. Alternatively, the data can be directly collected using a POST command over an HTTP/HTTPS interface 28.

The incoming sales data can be inserted directly into the post processor module 34 at the time of sale via DMMA or private network. The post processor module 34 writes the formatted record to the data repository 37 which may be any SQL database.

The incoming data posted by point-of-sales locations 10 and the Internet websites 23 is buffered in the record source modules 30 and passed on to parser modules 33. Parser modules 33 break the data up into individual records, and format the data in the appropriate format for the post processor module 34. The post processor module 34 writes the formatted record to the data repository 37 which may be any SQL database.

A report generator 35 is provided that is accessed by the affiliates 18, 19, 20 or clients 21, 22 through the GUI 38. A browser operating on an affiliate 18, 19, 20 or client 21, 22 workstation gains access through the HTTP/HTTPS interface 28 and the GUI 38 creates reports based on filter parameters selected by the users. Reports based on selected filter parameters are generated from the report generator 35 and transferred to the requesting affiliate 18, 19, 20 or client 21, 22 browser for analysis.

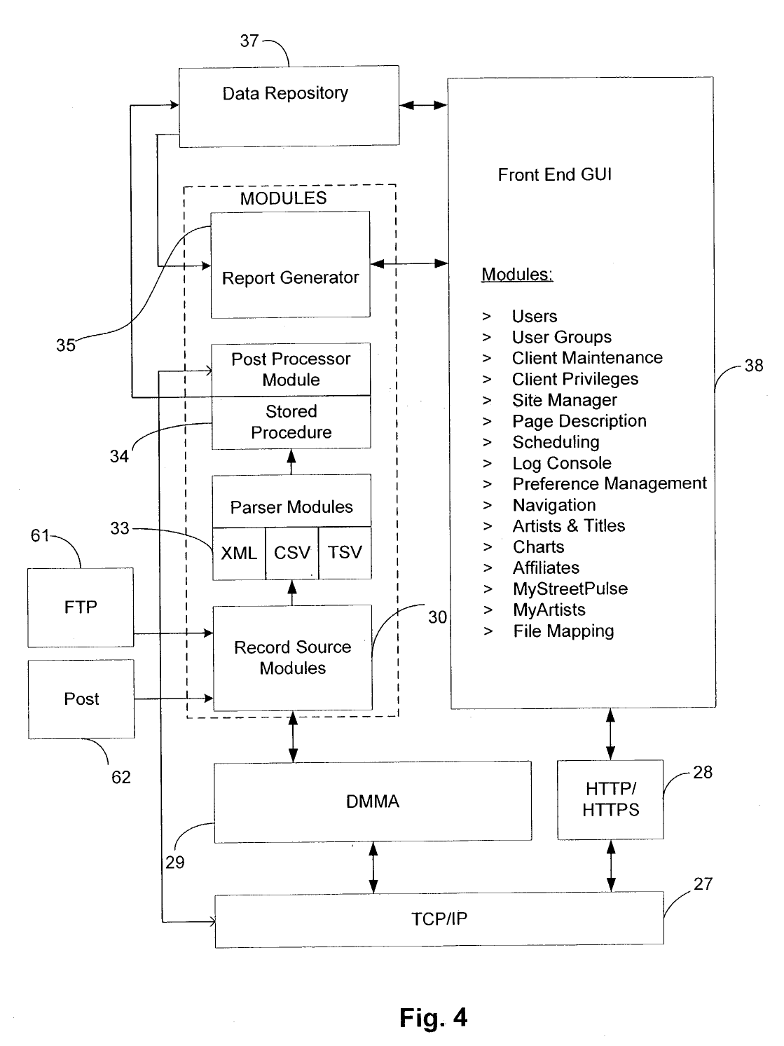

FIG. 4 represents a more detailed view of the collection agent 26. The architecture illustrated in FIG. 4 may comprise multiple processors, one serving as the front end GUI 38, and the other contains the various modules 30-35 for collecting, parsing and storing data in a data repository 37. The data repository 37 may be a SQL server, which is connected via a local ethernet connection between the processor having front-end GUI 38 and the processor executing the modules which comprises the collection agent. The affiliates 18-20 and clients 21-22 gain access to the data stored in the data repository 37 through a server application running on the processor of the front-end GUI 38 which will be described in greater detail.

The record source modules 30 receive data in a temporary storage data memory which is buffered after transfer through either the DMMA module 29 or a HTTP/HTTPS module 28. The data memory contents comprise either the log files of FIG. 3 from the Internet website 23, or the collection file 50 according to FIG. 2 received from the various point-of-sale locations 10. A portion of each file, which is buffered in memory, is accessed using a random access file stream. The location in the data memory of the record source modules 30 from which data was last read is saved, and is used as a starting point for reading subsequent portions of the buffered data. Each time buffered data is read, it is processed into individual records that will be sent to the parser modules 33 for processing.

The parser modules 33 include a parsing engine that processes each of the individual records received from the record source modules 30 as a series of lexemes. The parser modules 33 comprise an XML, CSV and TSV module, that, according to the file format of data being forwarded from the point-of-sales locations 10 or Internet websites 23, parses the data in two stages discussed in more detail below.

The first stage is a Parse Syntax stage that is responsible for parsing the record into a labeled hierarchical data structure that can be processed in the post processor module 33. The second stage is a Parsed Post Process stage that formats the data structure into a format suitable for output to the post processor module 34. In the case of the XML parser module, a configuration file is written to define the operations performed by the parser module 33 during each stage of processing. The configuration file specifies: (1) how to interpret each lexeme, (2) what operations to perform on each lexeme, (3) any operations to perform on portions of lexemes and (4) how to format the output. The parser component XML configuration file may consist of two sections, the Parse Syntax section and the Parse Post Process section. The Parse Syntax section defines how each lexeme in the record is to be processed, and this lexeme of the XML document is parsed into a Parse Syntax tree. For each record processed, each element in the Parse Syntax tree is applied to the corresponding lexeme. A value tree data structure is constructed containing the parsed record and labeled in hierarchical form that can be processed by the post processor module 34.

The Parsed Post Process section defines how to format values in the value tree into the format strings specified by the XML output element. The output string is passed onto the post processor module 34 for final processing.

The post processor module 34 expands the parsed data to include information taken from a stored UPC file and the zip code directory. Further, additional databases such as a Genre database may be provided for inclusion among records to be stored in the data repository 37 as additional information to that obtained from the point-of-sales locations 10 and Internet websites 23. The UPC file includes all information for expanding the received UPC 51 of FIG. 2 into the various components such as artist, label, distributor, etc., noted above. Several triggers and stored procedures act on the original information in the UPC field to look-up additional information from the UPC data source. The zip code contained in the record is used to either flag the new sales record as an international sale or a domestic sale with its appropriate region detail. Several other flags are set to designate the sales record into the type of music (genre), whether it is a sale by a major distributor, store or type of affiliate. The expanded information is available on a substantially real time basis with other sales information and records which have been acquired. Each of the records stored in the data repository 37 will include information relating to each reported sale or use of a pre-recorded product as well as the expanded information from the various databases received through FTP 61 and Post interfaces 62 shown in FIG. 4.

After receiving each sales record parsed from a CSV, TSV, or XML, a capture file is inserted into the database and, at the time of the insertion, several triggers and stored procedures act upon the original information received from the affiliates. For instance, the UPC field 51 is used to look up additional information from a UPC data source and the zip code is used to either flag the new sales record as an international sale or as a domestic sale with its appropriate region detail. Several other flags are set at this time to: (1) designate the sales record into the proper type of music (genre), (2) designate the sale as being from a major distributor, source or type of affiliate, (3) determine whether or not the sale is known to the system or not known, and (4) determine whether the Music Director needs to take further action. The processing period can be measured as a real-time transaction for the addition of information and flagging of the sales record takes place at insertion into the database. The sales record can be queried immediately from the GUI front-end and aggregated with other sales information and records acquired from other affiliates.

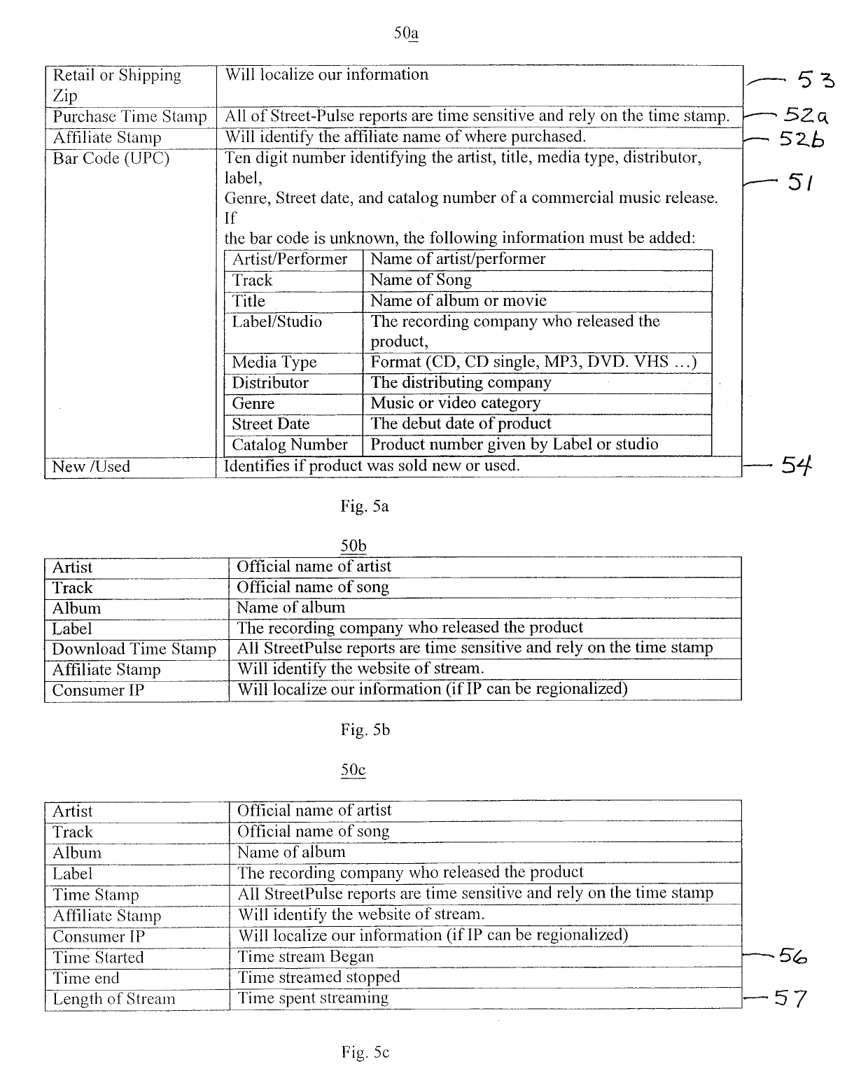

The stored data in the data repository 37 takes the forms shown in FIGS. 5a-5c. FIGS. 5a-5c illustrate three distinct forms of data records: (1) point-of-sales and Internet website sales records 50a, (2) downloads occurring over the Internet 50b that have been reported to the collection agent 26, and (3) streaming data records obtained from the log file 50c of an Internet website 23 which provides for streaming audio or video services.

The sales records 50a includes the UPC 51 retail location or shipping zip code 53, purchase time stamp 52a, the affiliate stamp 52b that identifies any Internet website 23 or point-of-sales locations 10 making the sale, and the new/used product field 54. The UPC 51 data is further broken down with the expanded information obtained from the local database.

The download record 50b includes the collected information shown in FIG. 5b. The streaming record is obtained from the log file 50c received from the Internet websites 23 providing this service. The information contained in the streaming record is expanded to identify information from the sales record 50a and the data shown in the streaming record.

The GUI 38 is part of a server application which runs at the collection agent 26. The affiliates 18-20 and clients 21-22 can access the server supporting GUI 38 via the Internet connection 15. The GUI 38 is organized to provide different levels of user privileges and easy access to data analysis reports and charts of the collected data in the database. Various access ID's and password ID's are given to affiliates 18, 19, 20 and clients, 21, 22 to access the collection agent 26 and generate data analysis reports and charts through the GUI 38. The GUI 38 can be broken down into several major modules that are common to a front-end GUI. The following are the major modules included in the GUI 38:

1. ARTISTS & TITLES;

2. VIDEO;

3. UNSIGNED/INDEPENDENTS;

4. AFFILIATES;

5. CHARTS; and

6. ADMINISTRATION.

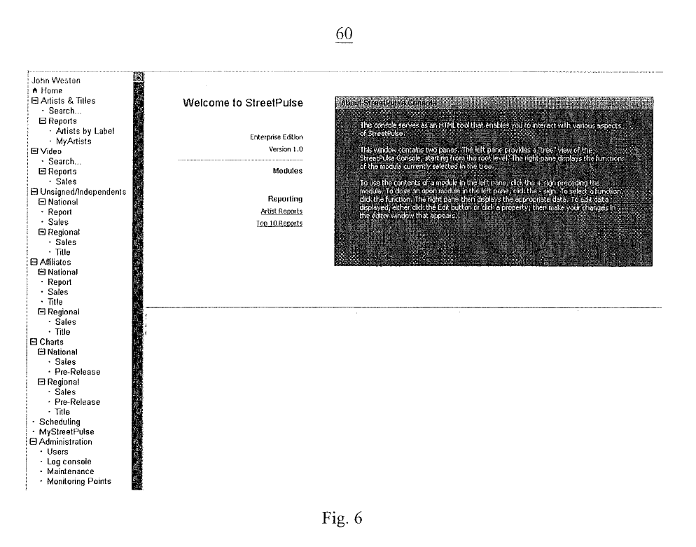

FIG. 6 is a screen display showing an example of a Main Menu screen 60 for the GUI that at least includes these major modules and their sub-modules. These major modules and their sub-modules will be further described below.

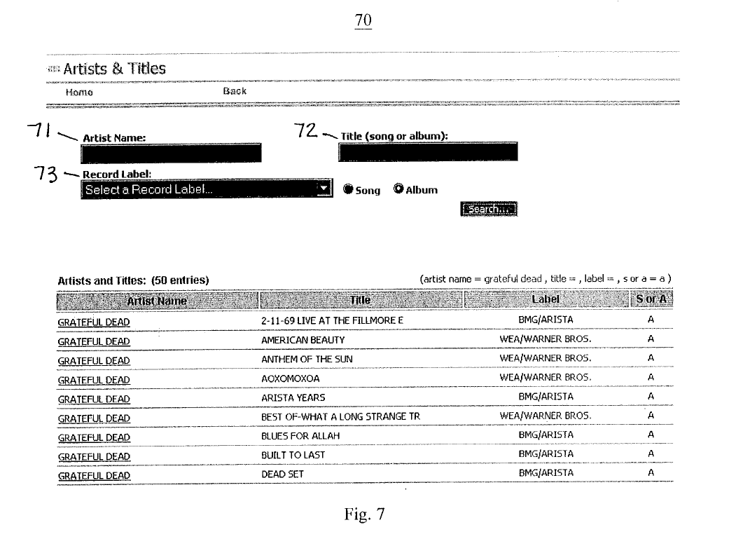

An ARTISTS & TITLES module is the general query area for artist, title, or label searches. The module accepts data entries of artist name 71, title (i.e., song or album) 72 and record label 73. FIG. 7 is a screen display showing an example of an ARTISTS & TITLES screen 70 of the GUI 38.

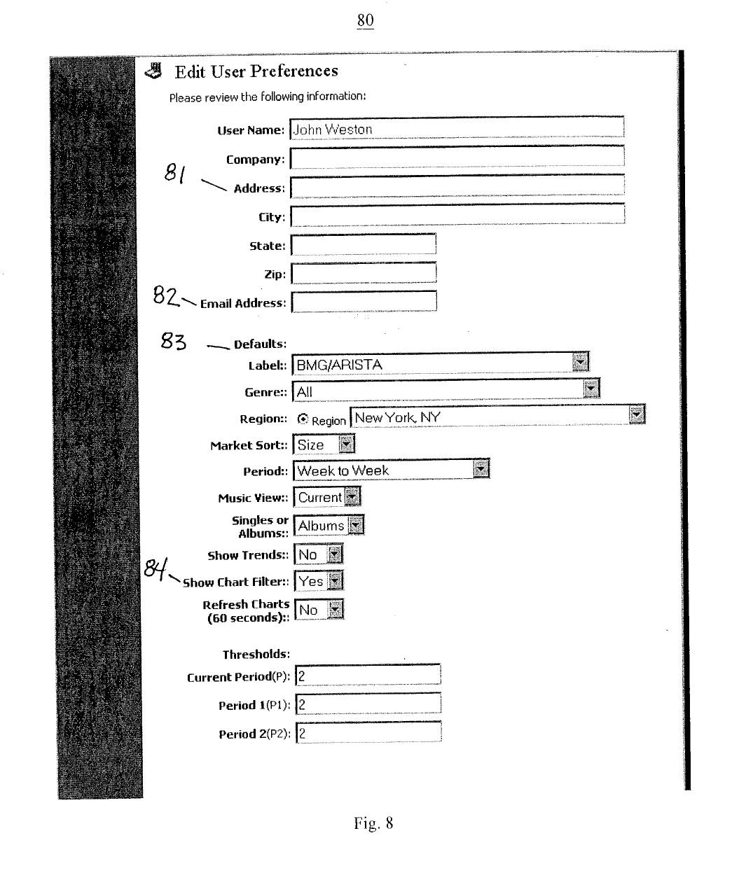

The contents of data analysis reports are determined by user preferences that are set during an edit of an Edit User Preferences screen 80, a non-limiting example of which, shown in FIG. 8, of the GUI 38. In the Edit User Preferences screen 80, the user can determine their preferences by entering data such as their Postal Address 81 and Email Address 82 as well as Defaults 83 that will be used in the reports that the user runs, unless overridden by the user. The Defaults 83 provide additional filters on the data viewed and will be further discussed below. If the user selects “NO” to the preference Show Chart Filter 84, all reports from that point on will be based on the preferences selected in the Edit User Preferences screen 80. Alternatively, if the user selects “YES” to the preference Show Chart Filter 84, the user may be prompted to select particular filters as further discussed below. The MYSTREET-PULSE sub-module allows a user to set up preferences or defaults.

In addition, filters provide an additional option in selecting user preferences. Filters give the user the ability to customize the contents of reports and charts that can be viewed. At the beginning of most requests for information, the user may be prompted to select filters that reduce the amount of data viewed. The following are non-limiting examples of the major filters that can be set in the Edit User Preferences screen:

1. Label;

2. Genre;

3. Region;

4. Market Sort;

5. Period;

6. Music/Video View (i.e., Current or All);

7. Format (i.e., Singles or Albums); and

8. Trend Threshold.

It should be noted that “current” refers to An item that has a street date of less than two years and a “trend” is a sales pattern that is determined by the difference in piece counts between periods.

A SEARCH sub-module allows the user to enter full or partial information, such as an artist's name, title (i.e., song or album name), or record label, and search the database for matching items. In the resulting list, the user then clicks on the artist or the title to generate an Artist Report. The Artist Report will contain all the titles by the selected artist that are in the system. The Artist Report will also contain information on each title, such as Label, for four time periods of national sales, streaming and downloading.

A REPORTS sub-module is based on specific user set filter parameters. The first time the user runs a report, they will be presented with an appropriate filter for the report selection. Once the parameters of the filter are set the user can choose to save the filter to avoid being prompted to enter the parameters again the next time the specific report is run. In addition, this option can be reset at any time using the MYSTREET-PULSE sub-module. FIG. 9 is a screen display showing a non-limiting example of a Report Filter screen 90 of the GUI 38. Before a query, the user must select Period 91, Music Type 92 and Genre 93, based on a pre-selected label preference.

An ARTISTS BY LABEL sub-module is the general area for information on artists. FIG. 10 is a screen display showing a non-limiting example of the Artist by Label screen 110 of the GUI 38. The Artists by Label sub-module defaults to an artist 111 that records for the label 113 selected in the Edit User Preferences screen 80. The report will also contain information on each title 112 such as label 113, for four time periods (i.e., P, P1, P2 P3) of national sales, streaming and downloading. A complete listing of sales 115, downloads 116 and streams 117 for selected artists for selected periods, and selected genre is provided as a report. A single screen overview of all selected active artists for sales 115, downloads 116 and streams 117 with 4 week trends may also be provided. Further, an overview isolating an artist's emerging activity is also available.

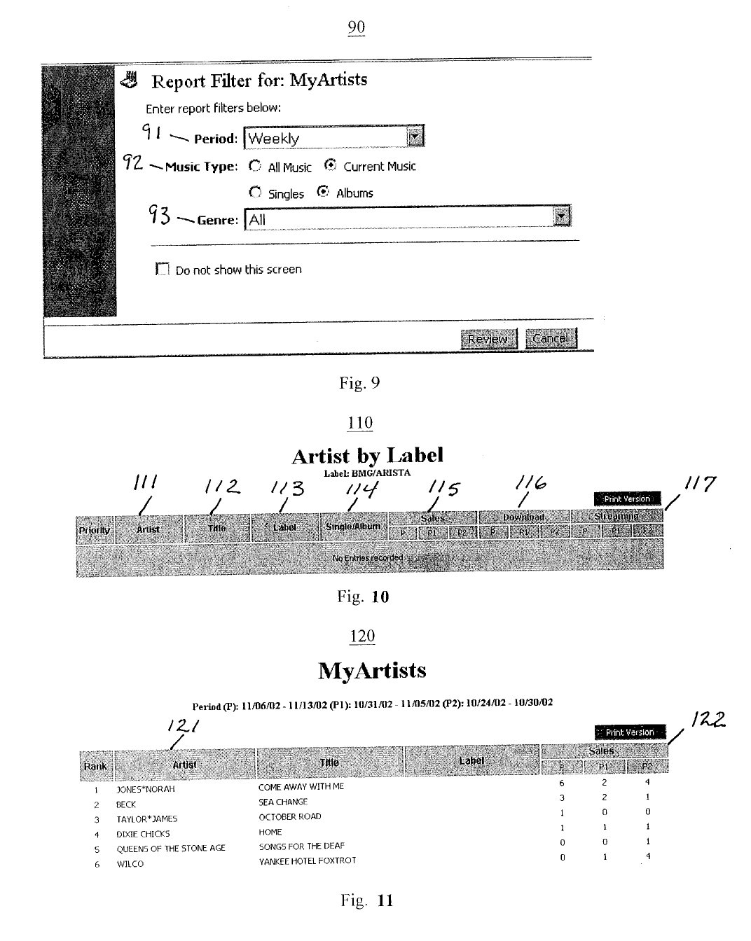

A MYARTISTS sub-module generates reports based on specific artists that the user has selected and added to their MyArtists list via the MYSTREET-PULSE screen. FIG. 11 is a screen display showing a non-limiting example of a MyArtists screen 120 of the GUI 38. Before the query, the user must select Period 91, Music Type 92 and Genre 93, as shown in FIG. 9. A complete listing of sales 122 for selected artists 121 for selected periods (i.e., P, P1, P2, P3) and selected genres is provided. This report may provide an overview for a label or an affiliate to select and isolate an artist's emerging activity.

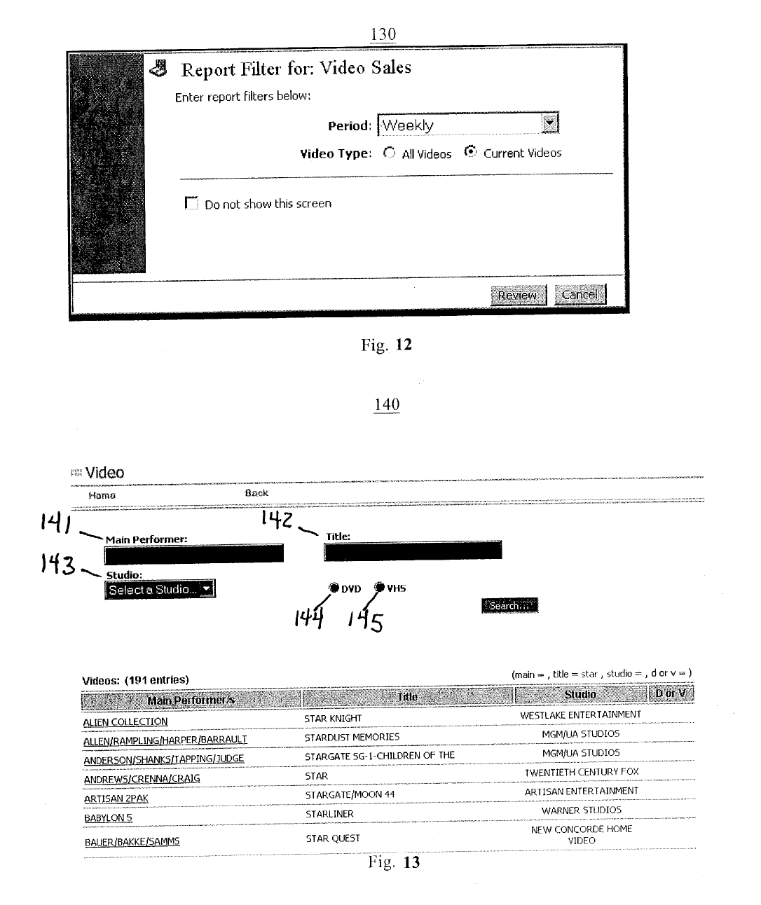

A VIDEO module generates reports that will be viewed by clients 21, 22 (e.g., studios) who seek sales research of pre-recorded video. This data gathering module is designed to identify emerging sales from the National, Regional, and Affiliate sub-modules. The results will provide the paying client with the ability to anticipate consumer demand vs. manufacturing supply, analyze local marketing strategies and compare their own sales to those of the competition. Reports such as Pre-release sales help paying clients anticipate consumer demand before the product is in the market place resulting in a more accurate initial production order from the manufacturer. All sub-modules are based on specific video filter parameters. FIG. 12 is a screen display of a non-limiting example of a Report Filter for Video sales screen 130 of the GUI 38.

A Video SEARCH sub-module is the general query area for artist, label, or title searches. The Video SEARCH sub-module accepts data entries of performer 141, title 142, studio 143, and video configuration (i.e., DVD 144 or VHS 145). In the resulting list, the user can then click on title to filter a video title report. FIG. 13 is a screen display of a non-limiting example of a National Video Sales screen 140 of the GUI 38.

In addition, under the VIDEO module, there are two separate types of sub-modules, NATIONAL and REGIONAL, both providing the same types of information in the report. The NATIONAL REPORT sub-module will show the entire picture for affiliate video sales and streams, while the REGIONAL REPORT will allow the label to look at specific areas, broken up into predefined cities and regions. The REGIONAL REPORT will have an additional filter option that will run reports specific to city or regions. All report sub-modules are based on specific user set filter parameters. The first time the user runs a report, the user will be presented with a filter appropriate to the report selection. Once the user sets the parameters, they can choose to save the filter to avoid being prompted to enter the parameters again or they can run the specific report. This option can be reset any time using the MYSTREET-PULSE screen.

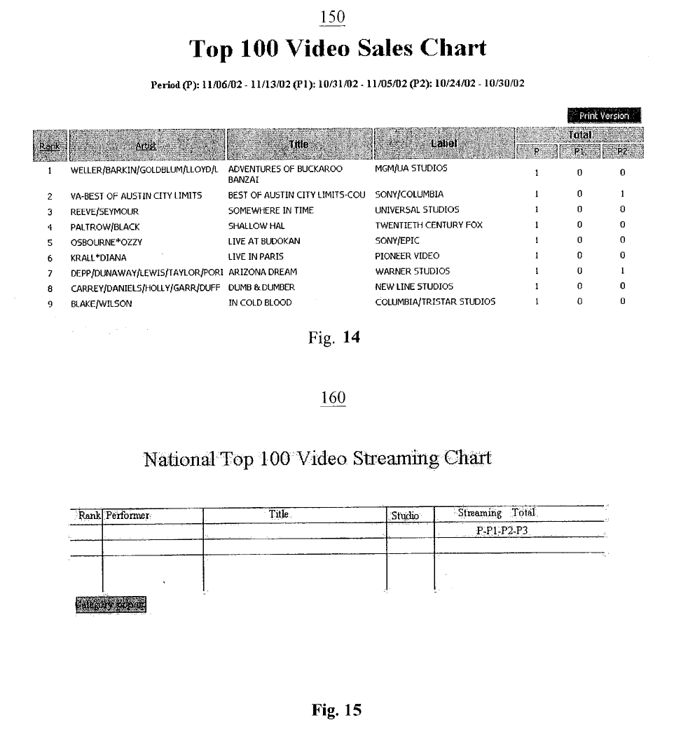

A SALES sub-module analyzes the sales, downloads and streaming performance of a pre-recorded product. For sales of prerecorded video products, a list of the top 100 videos sold by affiliates is generated. The report contains a four period run of DVD and VHS products sold. FIG. 14 is a screen display showing a non-limiting example of a Video Sales screen 150 of the GUI 38.

For downloads and streaming, a list of the top 100 streamed files from affiliates are generated. The report contains a four period run of streamed videos. FIG. 15 is a screen display showing a non-limiting example of a National Video Streaming screen 160 of the GUI 38.

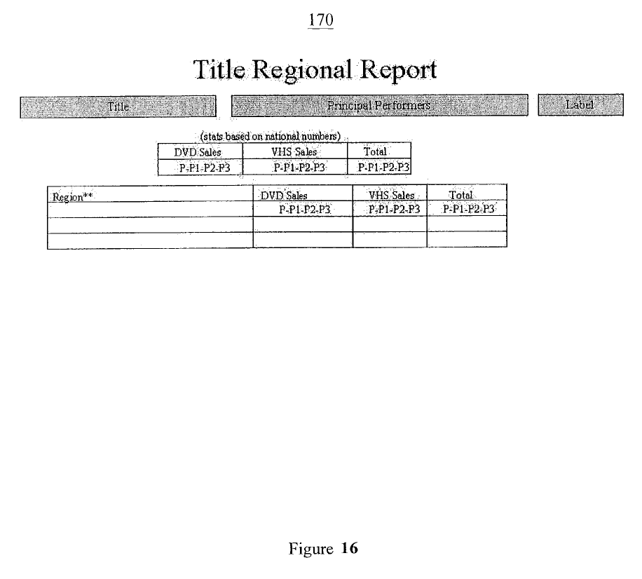

A TITLE sub-module charts video specific, measuring sales and trends in each region and a national trend overview in the header. This report provides information to paying clients on regions in which the video is established. The report returned includes the total product sold in each region. FIG. 16 is a screen display 170 showing a non-limiting example of a TITLE REGIONAL REPORT screen 170 of the GUI 38.

An UNSIGNED/INDEPENDENTS module generates reports that will be viewed by clients (e.g., major labels) who seek unsigned/ independent bands with built-in sales bases. Only artists that are not affiliated with a major label will be represented in this module. These results will serve to reassure a label of the commercial viability of an otherwise nationally unproven act (either nationally, regionally, or by affiliate) for possible new talent acquisition. Any Genre or “All” available. This report provides easy access for users only interested in one type of music.

Under the UNSIGNED/INDEPENDENTS module, there are two separate types of sub-modules, NATIONAL and REGIONAL, both providing the same types of information in the report. NATIONAL REPORT sub-module will show the entire picture for US affiliate sales, downloads and streams, while the REGIONAL REPORT will allow the label to look at specific areas, broken up into predefined regions. The REGIONAL REPORT will have an additional filter option that will allow you to run reports specific to city or regions. All chart sub-modules are based on specific user set filter parameters. The first time the user runs a report, the user will be presented with a filter appropriate to the report selection. Once the user sets the parameters, they can choose to save the filter to avoid being prompted to enter the parameters again or they can run the specific report. This option can be reset any time using the MYSTREET-PULSE screen.

The NATIONAL REPORT or REGIONAL REPORT sub-module provides information for national or regional activity on unsigned bands, or bands with no major label affiliation but that are doing well enough in terms of sales, downloads, and streams to statistically register. Before the query, the user must select period, music type, and genre, as shown in the non-limiting example of FIG. 9.

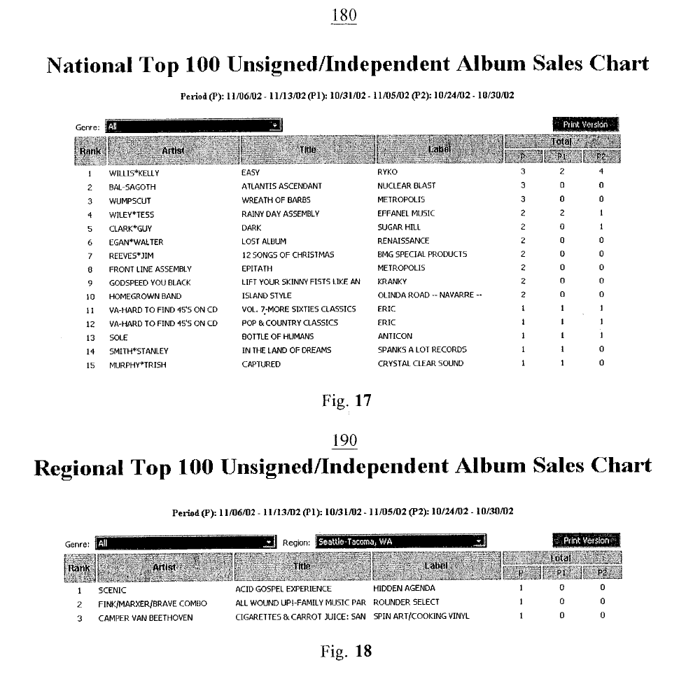

A SALES sub-module analyzes the sales, downloads and streaming performance of a pre-recorded product. For sales, a list of the top 100 singles or albums sold by the affiliate is generated. The report contains a four period run of CD's, or digital singles sold. FIG. 17 is a screen display showing a non-limiting example of a National Sales Report screen 180 of the GUI 38. The report returned includes rank, artist, title, label and time periods (P, P1, P2, P3). FIG. 18 is a screen display showing a non-limiting example of a Regional Sales Report screen 190 of the GUI 38.

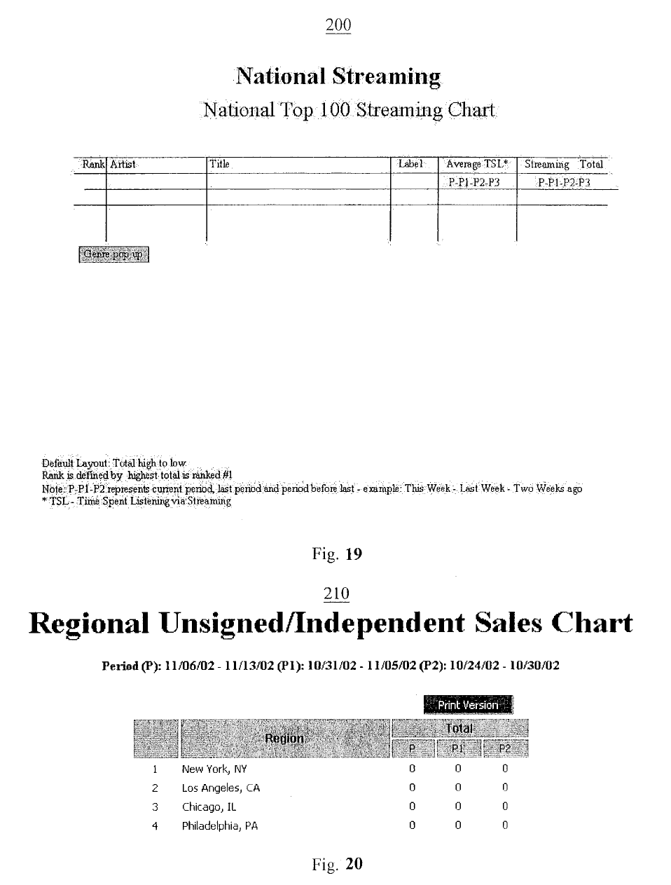

For downloads and streaming, a list of the top 100 downloaded files from the affiliates are generated. The report contains a four period run of songs streamed or downloaded from affiliates. The Streams report also contains the average time a user streams. The trend in average time spent listening can be viewed in the four periods. FIG. 19 is a screen display showing a non-limiting example of a National Streaming Report screen 200 of the GUI 38.

A TITLE sub-module charts album or song specific, measuring sales and trends in each region and a national trend overview in header. This report provides information to a major label on regions in which the unsigned or independent artist is established. Before the query, the user must select an album or title and time period. The report returned includes the total product sold in each region. FIG. 20 is a screen display showing a non-limiting example of a TITLE REGIONAL REPORT screen 210 of the GUI 38.

An AFFILIATES module provides contributing affiliates the ability to view their location's activity and/or the regional/national activity. However, no affiliate can specifically see another specific affiliate's information.

In addition, under the AFFILIATES module, there are two separate types of chart sub-modules, NATIONAL and REGIONAL, both with the same type of report. NATIONAL REPORT sub-module will show the entire US picture for affiliate sales, downloads and streams, while the REGIONAL REPORT will allow the affiliate to look at specific areas, broken up into predefined cities and regions. The REGIONAL REPORT will have an additional filter option that will allow you to run reports specific to city or regions. All chart sub-modules are based on specific user set filter parameters. The first time the user runs a report, the user will be presented with a filter appropriate to the report selection. Once the user sets the parameters, they can choose to save the filter to avoid being prompted to enter the parameters again or they can run the specific report. This option can be reset any time using the MYSTREET-PULSE screen.

The NATIONAL REPORT or REGIONAL REPORT sub-module provides information for national or regional activity on artists that are doing well enough in terms of sales, downloads, and streams to statistically register. Before the query, the user must select period, music type, and genre. The report returned includes rank, artist, title, label, total (i.e., time period breakdown).

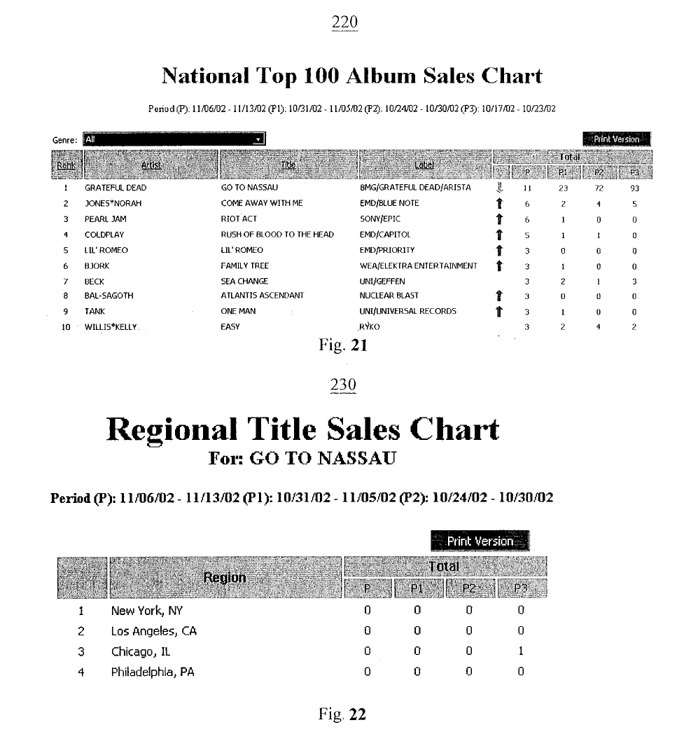

A SALES sub-module analyzes the performance of sales, downloads and streaming of a pre-recorded product. For sales, a list of the top 100 singles or albums sold by the affiliate is generated. The report contains a four period run of CD's, or digital singles sold. FIG. 21 is a screen display showing a non-limiting example of a National Sales Report screen 220 of the GUI 38. FIG. 22 is a screen display showing a non-limiting example of a Regional Sales Report screen 230 of the GUI 38.

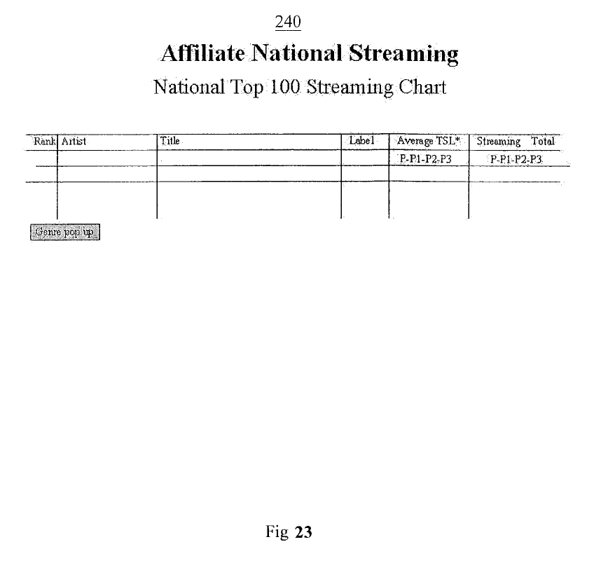

For downloads and streaming, a list of the top 100 downloaded files from the selected affiliate is generated. The report contains a four period run of songs streamed or downloaded from selected affiliate. The Streams report also contains the average time a user streams. The trend in average time spent listening can be view in the four periods. FIG. 23 is a screen display showing a non-limiting example of an Affiliate National Streaming Report screen 240 of the GUI 38.

A TITLE sub-module charts album or song specific, measuring sales and trends in each region and a national trend overview in header. This report provides information to a user on what regions the selected artist is established in. Before the query, the user must select an album or title and time period. The report returned includes the total product sold in each region. This report provides information reflecting affiliate sales activity and trends in cities or regions throughout the country. This chart is album or song specific, measuring sales and trends in each region and a national trend overview in header. This report informs an affiliate in what regions the artist has established themselves.

A CHARTS module generates reports on pre-sales, top 100 sales, downloads and streaming charts. This data gathering module is much more likely to identify emerging talent than background art charts which are weighted by the top national acts dominating the mass merchants. A user can see an emerging national sales trend by examining information on a regional basis, where trends often start.

In addition, under the CHARTS module, there are two separate types of chart sub-modules, NATIONAL and REGIONAL, both with the same type of report. NATIONAL REPORT sub-module will show the entire picture for US affiliate sales, downloads and streams, while the REGIONAL REPORT will allow the label to look at specific areas, broken up into predefined cities and regions. The REGIONAL REPORT will have an additional filter option that will allow you to run reports specific to cities or regions. All chart sub-modules are based on specific user set filter parameters. The first time the user runs a report, the user will be presented with a filter appropriate to the report selection. Once the user sets the parameters, they can choose to save the filter to avoid being prompted to enter the parameters again or they can run the specific report. This option can be reset any time using the MYSTREET-PULSE screen.

The NATIONAL REPORT or REGIONAL REPORT sub-module provides information for national or regional activity on artists that are doing well enough in terms of sales, downloads, and streams to statistically register. Before the query, the user must select period, music type, and genre. The report returned includes rank, artist, title, label, and time periods.

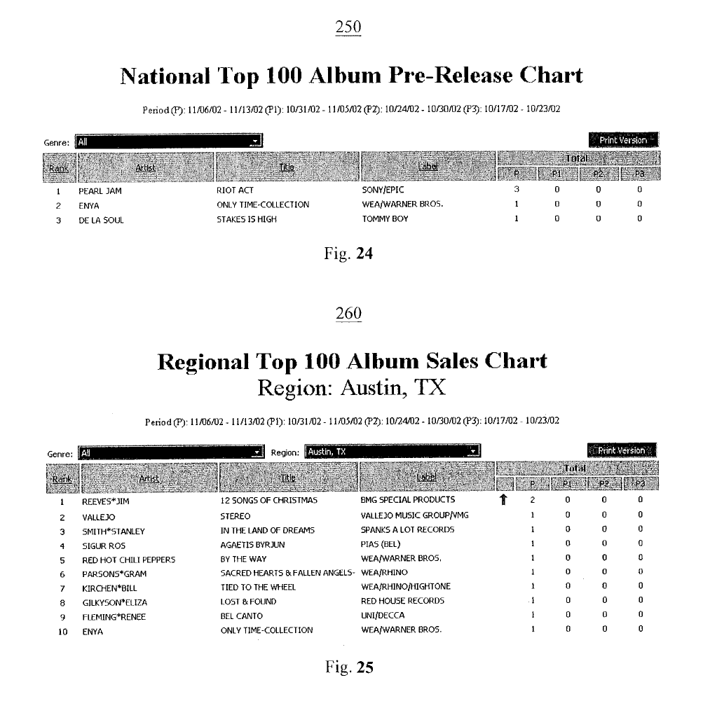

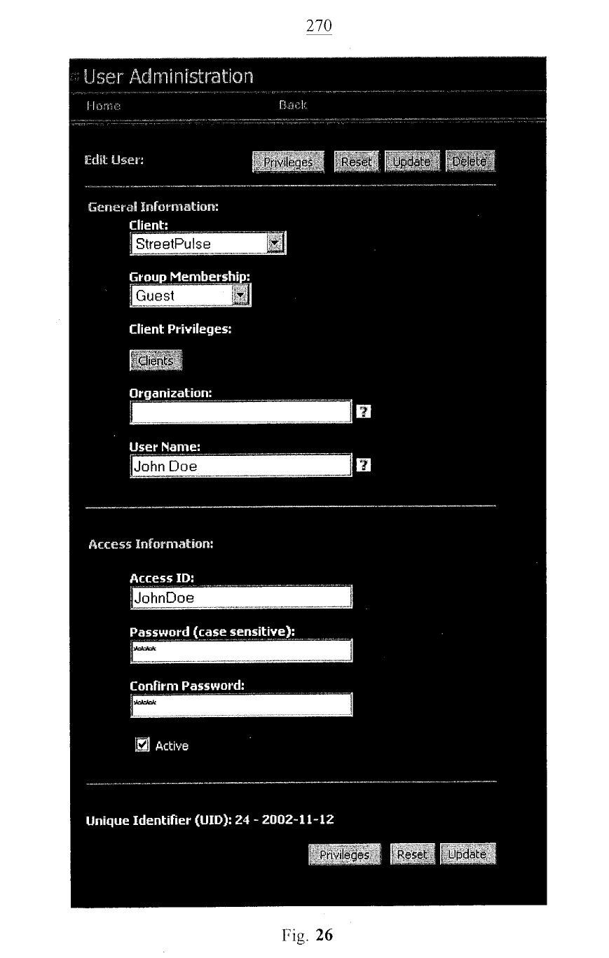

A SALES sub-module analyzes the sales, downloads and streaming performance of a pre-recorded product. For sales, a list of the top 100 singles or albums sold by the affiliates is generated. The report contains a four period run of CD's, or digital singles sold. FIG. 24 is a screen display showing a non-limiting example of a National Sales Chart screen 250 of the GUI 38. FIG. 25 is a screen display showing a non-limiting example of a Regional Sales Chart screen 260 of the GUI 38.

For downloads and streaming, a list of the top 100 downloaded files from the selected affiliate is generated. The report contains a four period run of songs streamed or downloaded from selected affiliate. The Streams report also contains the average time a user streams. The trend in average time spent listening can be view in the four periods.

A PRE-RELEASE sub-module analyzes the performance of a pre-recorded product. Pre-release sales help paying clients anticipate consumer demand before the product is in the market place resulting in a more accurate initial production order from the manufacturer.

A TITLE sub-module charts album or song specific, measuring sales and trends in each region and a national trend overview in header. This report provides information to a major user on what regions an artist is established in. Before the query, the user must select an album or title and time period. The report returned includes the total product sold in each region. This report provides information reflecting sales activity and trends in cities or regions throughout the country. This chart is album or song specific, measuring sales and trends in each region and a national trend overview in header. This report informs a user in what regions the artist is already established.

A SCHEDULING sub-module allows clients to set up pre-defined reports based on National, Regional or Title layouts. Each report will be set to run at specific times selected by the user. Once these reports have been generated, they will be stored online and/or emailed to the user. This sub-module will be used by clients that only need specific reports and not access to the full on-line system.

An ADMINISTRATION module used by the administrators of the system such as programmer, subscription manager, Music Director and any other users that are responsible for the information content. This module gives the user access to Users, Log Console, Maintenance, and Monitoring points. FIG. 26 is a screen display showing a non-limiting example of an ADMINISTRATION screen 270 of the GUI 38.

A USERS sub-module allows the administrator to add, edit and delete user, user groups and their associated privileges. The administrator, through the USERS sub-module, gives groups and users access privileges to the sites modules. Each group is assigned access to selected modules while users can have restrictions within the selection. The USERS sub-module contains three sections: LIST OF USERS, USER GROUPS, and CREATE NEW USER. LIST OF USERS section allows administrator to edit user privileges, and a delete users, change assigned group, client level and username and password. The USER GROUPS section gives the administrator the right to add and delete groups along with assign privileges. The CREATE NEW USER section simply gives the administrator the ability to add a new user to the system.

A LOG CONSOLE sub-module may view all activities performed by various users such as who generated reports and when, who logged in and when, administrator activities, etc. The administrator can view and sort the logs in many ways as well as rollover the log file into the log archives. The administrator may access the log archives from this area if it is desired to look at past user activities. Other functions include viewing update logs and error logs.

A MAINTENANCE sub-module for application maintenance by the administrator that includes:

MUSIC DIRECTOR;

CLIENT INFORMATION;

RDBMS ADMINISTRATION;

RECORD LABELS;

GENRES;

REGION UPDATE;

UPC FILE UPDATE; and

SALES DATA UPDATE.

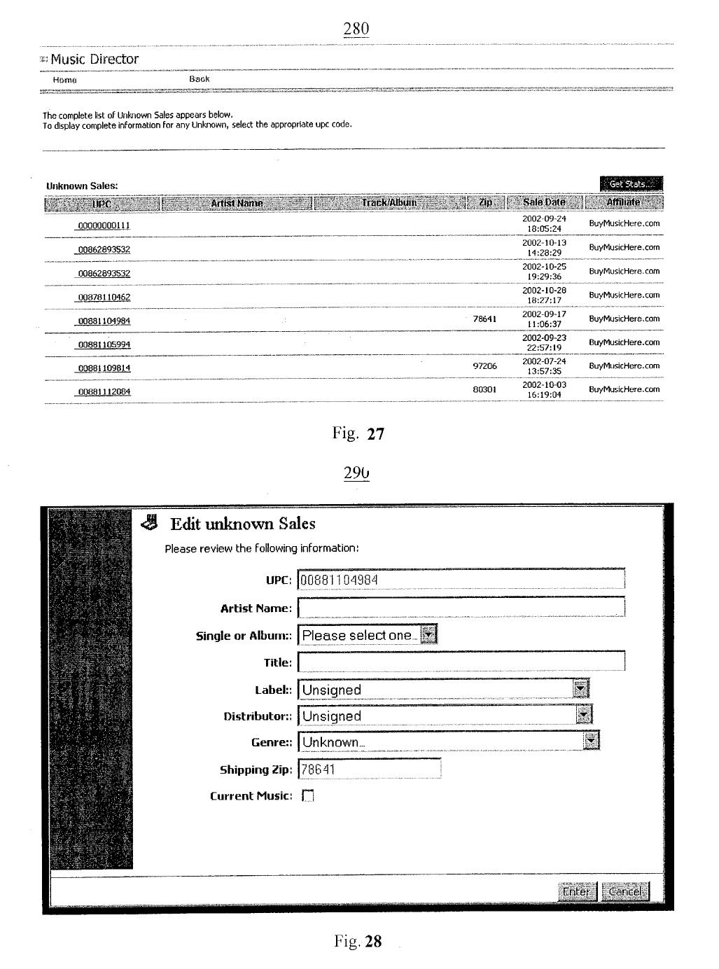

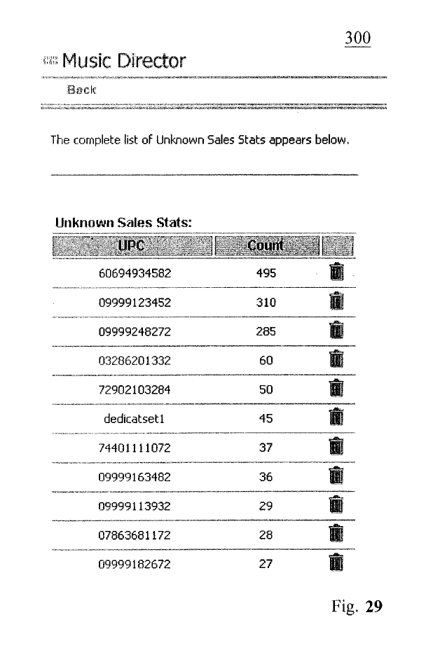

A MUSIC DIRECTOR sub-module gives the administrator access to the information content of the application. FIG. 27 is a screen display showing a non-limiting example of a MUSIC DIRECTOR screen 280 of the GUI 38. The sub-module is in two sections, an UNKNOWN MANAGEMENT section and DATA COLLECTION LOGS section. The UNKNOWN MANAGEMENT section allows the administrator to identify any unknown UPC number that enters the application or delete the number if it is not needed. The sub-module lists the UPC number 281 along with time stamp of sale date 285 and name of affiliate 286 where purchased. The list is in numerical order and each line represents an individual unknown UPC sale. Administrator can then add necessary information in an Edit Unknown Sales screen by double clicking on a selected unknown UPC number. FIG. 28 is a screen display of a non-limiting example of an Edit Unknown Sales screen 290 of the GUI 38. The administrator can also view an aggregation of unknown UPC numbers in the Unknown Sales Stats screen 380, a non-limiting example of which is shown on FIG. 29. The stats prioritize the unknown UPC numbers for the administrator to identify. The system also includes a variety of sub-modules to permit the system administrator to configure the collection agent. These sub-modules include the following:

A CLIENT INFORMATION sub-module for adding new types of clients or affiliates. Real-time monitoring technology can be used in a variety of ways including everything from book or hardware safes to inventory management in a commercial logistics environment. The client information sub-module allows the administrator to add such clients or edit existing clients and their associated contacts.

An RDBMS ADMINISTRATION sub-module allows the administrator to select the database type (e.g., Oracle or Microsoft SQL) and the data source name.

A RECORD LABELS sub-module allows the administrator to manually add and remove record labels.

A GENRES sub-module allows the administrator to manually add and remove music genres.

A UPC FILE UPDATE sub-module that receives an updated flat file database that includes new artists, songs and albums released each week. This sub-module imports the data from this flat file into the overall database.

A SALES DATA FILE UPDATE sub-module allows the administrator to manually feed affiliate export files into the application.

A MONITORING POINTS sub-module provides for the administration maintenance for data collection agents and functionality changes.

A CLIENT sub-module allows administration of data collection agents and allows for maintenance of these agents including distribution of updated agent code. In addition, this sub-module allows for remote administration of all agents in the field without having to travel onsite or involve the affiliate running the agent.

A CODE sub-module allows for the administration of all code modules that have been incorporated into the GUI 38. New modules that provide new functionality or change the parameters of existing modules can be added through this part of the GUI 38.

The foregoing description of the invention illustrates and describes the present invention. Additionally, the disclosure shows and describes only the preferred embodiments of the invention in the context for collecting and analyzing the sale and use of pre-recorded audio/video products, but, as mentioned above, it is to be understood that the invention is capable of use in various other combinations, modifications, and environments and is capable of changes or modifications within the scope of the inventive concept as expressed herein, commensurate with the above teachings and/or the skill or knowledge of the relevant art including, but not limited to, video game software and electronic books which are machine readable. The embodiments described hereinabove are further intended to explain best modes known of practicing the invention and to enable others skilled in the art to utilize the invention in such, or other, embodiments and with the various modifications required by the particular applications or uses of the invention. Accordingly, the description is not intended to limit the invention to the form or application disclosed herein. Also, it is intended that the appended claims be construed to include alternative embodiments.

What is claimed:

1. A method for collecting and analyzing sales of pre-recorded entertainment products comprising:
collecting point-of-sale information identifying each purchase of at least one of said pre-recorded products;
creating a database of said point-of-sale information;
creating a file of said point-of-sale information;
transferring said file on a periodic basis over a network to a specified address;
receiving said file at said specified address;
parsing said point-of-sale information into individual data fields;
expanding said point-of-sale information to include data relating to each pre-recorded product identified in said point-of-sale information;
storing said expanded point-of-sale information in a data repository;
and
accessing selected portions of said expanded point-of-sale information to determine consumer preferences.

2. The method according to claim 1, wherein said network is the Internet.

3. The method according to claim 1, wherein said point-of-sale information includes a UPC code that is expanded into product information for storing in said data repository.

4. The method according to claim 1, further comprising:
expanding said information on each purchase to identify a geographical location of each purchase.

5. The method according to claim 1, wherein said point-of-sale information is collected at a point-of-sale by reading bar code information from each pre-recorded product sold.

6. The method according to claim 1, further comprising;
adding a time stamp to said collected point-of-sale information to identify a time of sale of each pre-recorded product.

7. The method according to claim 1, wherein said step of accessing said selected portions of said expanded portions of said point-of-sale information comprises:
defining a filter that contains data of interest for a user; and
using a graphical user interface to access a set of data defined by said filter.

8. The method according to claim 7, wherein said filter identifies a time period over which data of interest is to be accessed.

9. The method according to claim 7, wherein said filter identifies a set of data common to a specific artist.

10. The method according to claim 1, wherein said step of accessing said selected portions of said expanded point-of-sale information comprises:
using a browser application running in at least one of a client and an affiliate location to remotely access data of interest in said data repository.

11. The method according to claim 10, wherein said data of interest is defined by selecting filter parameters through said browser application.

12. A method for collecting and analyzing information relating to the sale of entertainment products comprising:
receiving point-of-sale information identifying each sale of at least one of said entertainment products from a remote sales location;
parsing said point-of-sale information into individual data fields;
expanding said point-of-sale information to include data relating to each pre-recorded product identified in said point-of-sale information;
storing said expanded point-of-sale information in a data repository; and
accessing selected portions of said expanded point-of-sale information to determine consumer preferences.

13. The method according to claim 12, wherein said step of accessing said selected portions of said expanded point-of-sale information comprises:
using a browser application, operated by at least one of a client and an affiliate, to remotely access data of interest in said data repository.

14. The method according to claim 13, wherein said data of interest is defined by selecting filter parameters through said browser application.

15. The method according to claim 12, wherein said step of accessing said selected portions of said expanded point-of-sale information comprises:
defining a filter that contains data of interest for a user; and
using a graphical user interface to access a set of data defined by said filter.

16. The method according to claim 15, wherein said filter identifies a time period over which data of interest is to be accessed.

17. The method according to claim 15, wherein said filter identifies a set of data common to a specific artist.

18. A system for collecting and analyzing customer purchasing preferences for entertainment products comprising:
a plurality of point-of-sale terminals, each of said terminals including:
(a) means for inputting sales data for each pre-recorded product sold;
(b) means for storing said sales data; and
(c) means for exporting said sales data at periodic intervals;
a network connected to each of said point-of-sale terminals;
an agent connected to said network to receive exported data from said plurality of point-of-sale terminals, said agent including a processor, a data repository and a graphical user interface, said processor being programmed to:
(a) parse said exported data into individual data fields;
(b) expand said parsed data with locally stored data; and
(c) store said expanded data in said data repository; and
at least one of a client terminal and an affiliate terminal connected to said network for accessing said expanded data in said data repository.

19. The system according to claim 18, wherein said network is the Internet.

20. The system according to claim 18, wherein said at least one of a client terminal and an affiliate terminal includes a browser application for accessing said graphical user interface of said agent.

21. The system according to claim 18, wherein said at least one of a client terminal and an affiliate terminal selects filter parameters via said browser application for identifying to said graphical user interface data to be accessed by said at least one of a client terminal and an affiliate terminal.

22. The system according to claim 18, wherein said means for inputting sales data includes a bar code scanning device for reading bar code indicia on each pre-recorded product sold.

23. The system according to claim 18, wherein said sales data includes a time stamp for identifying a time of a respective transaction.

24. The system according to claim 18, wherein said sales data includes a postal code identifying where the sale is taking place.

25. The system according to claim 18, wherein said sales data identifies said sale as a sale of one of new and used products.

26. A system for collecting and analyzing customer listening preferences for pre-recorded audio and video products that are accessible over a network comprising:
at least one server connected to said network, said at least one server having a library of pre-recorded audio and video products that are selectable by at least one of a client and an affiliate connected to said network; said at least one server including:
(a) means for identifying each of said pre-recorded products accessed by a client said at least one of a client and an affiliate;
(b) means for storing sales data identifying at least one of said pre-recorded products; and
(c) means for exporting said sales data at periodic intervals;
an agent connected to said network, having an address to receive data exported by said at least one server, said agent including a processor, a data repository and graphical user interface, said processor being programmed to:
(d) parse said exported data into individual data fields;
(e) expand said parsed data with locally stored data; and
(f) store said expanded data in said data repository.

27. The system according to claim 26, wherein said network is the Internet.

28. The system of claim 26, further comprising:
at least one of said client terminal and affiliate terminal having a browser connected to the Internet for accessing said expanded data through said graphical user interface.

29. The system of claim 26, wherein at least one of said client terminal and affiliate terminal includes a browser application that selects parameters of a filter for identifying data to be accessed.

30. The system of claim 26, further comprising means for collecting demographic information of said customer and storing said demographic information in said data repository.

31. A method for analyzing and presenting data collected by a collected by a collection agent comprising:
providing different levels of access to the data collected for clients and affiliates;
accepting data analysis requests from said clients and affiliates;
accepting user preference inputs from said clients and affiliates to filter the analysis of the data collected;
accepting filter inputs from said clients and affiliates to further filter the analysis of the data collected;
analyzing the data collected according to the data analysis requests, user preference inputs and filter inputs; and
presenting the results of the analysis of the data collected.

32. The method of claim 31, wherein the access is determined by at least one of an access identification number and a password.

33. The method of claim 31, wherein the data analysis request is for a search of the data collected by at least one of an artist, a title and a label.

34. The method of claim 31, wherein the user preference inputs are at least one of a postal address and an E-mail address.

35. The method of claim 31, wherein the user preference inputs further includes a default input that makes the filter inputs available to the user.

36. The method of claim 31, wherein the filter inputs are at least one of a label, a genre, a region, a market sort, a period, a view, a format and a threshold.

37. The method of claim 31, wherein the data collected is collected in real-time.

38. The method of claim 31, wherein the results of the analysis of the data collected is presented in report form.

39. The method of claim 31, wherein the results of the analysis of the data collected is presented in chart form.

40. The method of claim 31, wherein the results of the analysis of the data collected includes at least four time periods.

41. The method of claim 31, wherein the results of the analysis of the data collected can be set to run at specified times.

42. The method of claim 31, wherein the results of the analysis of the data collected includes downloading data.

43. The method of claim 31, wherein the results of the analysis of the data collected includes analysis of on-line sales data.

44. The method of claim 31, wherein the results of the analysis of the data collected includes analysis of streaming data.

45. The method of claim 31, wherein the results of the analysis of the data collected includes analysis of downloading data.

46. The method of claim 40, wherein at least one of the client and affiliate selects the time periods.

47. The method of claim 41, wherein the results of the analysis of the streaming data includes at least one of streaming duration, time of streaming and number of streams.

48. A method for analyzing sales and use data of prerecorded entertainment products which identify said products by date and time of sale or use which are collected by an agent on a substantially real time basis comprising:
establishing a data link between a client or affiliate terminal and said collection agent;
selecting through a graphical interface of said collection agent filter parameters representing a time period in which said products were sold or used;
recovering data from a data repository of said agent matching said filter parameters; and
reporting to said client and affiliate terminals said recovered data.

49. The method for analyzing sales and use data according to claim 48 wherein said filter parameters further identify a specific region in which such sales or use took place.

50. The method for analyzing sales and use data according to claim 49 wherein said reported data includes a complete list of sales and downloads of said prerecorded products occurring in said time period.

51. The method for analyzing sales and use data according to claim 49 wherein said recovered data includes the duration of any data streams occurring in said time period.

52. The method for analyzing sales and use data according to claim 49 wherein said filter parameters further identify sales of products by a specific artist.
